(19) United States
(12) Patent Application Publication
(10) Pub. No.: US 2012/0005906 A1
(43) Pub. Date: Jan. 12, 2012

(54) Guiding System for Power Tools

(75) Inventors: Thilo Koeder, Gerlingen (DE); Joachim Platzer, Remseck-Hochberg (DE)

(73) Assignee: Robert Bosch GmbH, Stuttgart (DE)

(21) Appl. No.: 13/141,645

(22) PCT Filed: Dec. 11, 2009
(86) PCT No.: PCT/EP2009/066939

§ 371 Date: Sep. 12, 2011

(30) Foreign Application Priority Data
Dec. 22, 2008 (DE) 102008055061.2

(51) Int. Cl. B23D 51/02; B23D 49/16; H01J 40/14

(52) U.S. Cl. 30/392; 250/221; 83/368

(57) ABSTRACT

A power tool, particularly in the form of a keyhole saw as a hand-held power tool includes a work tool. A working line to be followed by the work tool with respect to the workpiece is optically provided by the power tool without contact being involved.

The invention relates to a guiding system for power tools, in particular hand-held power tools, according to the preamble of claim 1

### PRIOR ART

Guiding systems for power tools are known in many different configurations. Common guiding systems in use are in particular mechanical guiding systems in which the respective power tool is guided along a guide path provided on the workpiece, for example along an edge of the workpiece via a guide shoe, which is adjustably fastened relative to the machine via an extension arm.

Furthermore, guiding systems working on an optical basis are also known, thus, for example, from DE 10 2006 052 808 A1, in which guiding systems a contour to be followed as a working line by the tool is marked on the surface of a workpiece and is detected via a sensory system, in particular in the form of a camera, provided on the machine. In this known solution, which relates to a power tool in the form of a jigsaw having a saw blade driven in a reciprocating manner, the saw blade, which is rotatable about the stroke axis, is oriented toward the working line in a computer-aided manner via a control and actuating device on the basis of the detected data, thereby making possible a semiautonomous operation of the power tool. With such a semiautonomous working operation, only a relatively coarse presetting of the working direction by the user is necessary, since the exact positioning of the tool relative to the working line is carried out via the adjustment of said tool.

The semiautonomous mode of operation which is helpful for the user, in particular also in the hobby sector, leads to very advantageous work results, but requires a corresponding marking on the top of the workpiece with sufficient contrast to the surface condition of the workpiece. On sensitive surfaces, such a high-contrast marking can partly only be realized with difficulty without damaging the surface, but this is also the case with unevenly textured surfaces or mottled surfaces. There are therefore to some extent still certain restrictions when using such power tools.

### DISCLOSURE OF THE INVENTION

The object of the invention is to show a further guiding system for power tools of the type mentioned at the beginning, said guiding system being distinguished by high guiding quality and ruling out damage to the workpiece, in particular damage to the surface thereof, in conjunction with the predetermination of the working line.

According to the invention, this is achieved with the features of claim 1. The further claims relate to the configuration of such guiding systems with expedient details for the realization thereof.

According to the invention, the working line to be followed on the workpiece by the tool of the power tool is predetermined optically relative to the workpiece in a non-contact manner. Thus, with the predetermination of the working line relative to the workpiece, it is unnecessary to interfere with the workpiece and, depending on the type of optical predetermination of the working line, this also opens up the possibility of making the detection of said working line virtually independent of ambient conditions, thus also of the texturing and/or coloring of the respective surface, when following the working line as required for the working operation. This applies in particular when predetermining the working line by means of a light beam, in which case, as a result of the nature of the respective light, that is to say of the wavelength of the emitted light, and possibly also as a result of the modulation thereof, it is largely possible to ensure that the light beam can be recognized and is detected on the machine irrespective of ambient conditions. In principle, it is possible in this case to make these arrangements largely without taking into account the capacity of the user to recognize the working line if the respective power tool is provided with an optical indicating device, for instance a display, which makes the orientation of the machine relative to the working line clear to the user.

There are various possibilities for the representation of the working line, thus, for example, by the projection thereof onto the workpiece surface by means of a light beam running along the surface toward the detection unit or by the projection onto the workpiece surface by means of a light beam oriented toward the workpiece surface transversely thereto, as a result of which different optical projectors can also be used, which, for example, are put onto the workpiece surface or are used outside the workpiece in corresponding extension to the workpiece surface or above the workpiece surface with orientation toward the workpiece surface.

However, it is also within the scope of the invention to orient the light beam in a focused manner toward the detection unit, whereby there is merely a virtual representation of the working line on the workpiece surface in accordance with this light beam, although this representation of the working line can be recognized when the light is visible to the user.

Suitable optical projectors within the scope of the invention are in particular laser light emitters, specifically, depending on the type of representation of the working line required, in the form of a line laser light emitter or an optical projector for free contours. Via the latter, given an appropriate arrangement above the workpiece surface, working lines which have a course deviating from a straight line, for example the course of a wavy line, can also be represented.

According to the invention, the detection unit is formed by a sensor system, in particular a camera system, the signals of which are fed to a downstream computing or control unit and are converted via the latter into guide instructions for the user and/or actuating commands for the machine or the work tool thereof. If the signals are only converted into guide instructions for the user, such a system is likewise suitable for a hand-guided power tool without mechanical assistance in the guidance work, since it assists the user in the guidance work and in particular also permits working accuracy which is still sufficient for many purposes even under more difficult visual conditions. The conversion into actuating commands for the work tool is especially suitable for the semiautonomous operation, and this in particular in the configuration of the power tool as a jigsaw, the saw blade of which can be rotated about the stroke axis thereof and which is oriented via the actuating commands so as to follow the respective working line by rotation about the stroke axis.

In practical implementation of the guiding system according to the invention, it proves to be expedient to combine the, in particular electrically driven, hand-held power tool together with the respective optical projector, that is to say, for example, a line laser, as accessory to form a machine set, possibly with a further accessory, such that there is in each case a working unit with which all normal possible uses can be at least substantially covered.

Further advantages and expedient embodiments can be seen from the claims, the description of the figures and the drawings, in which:

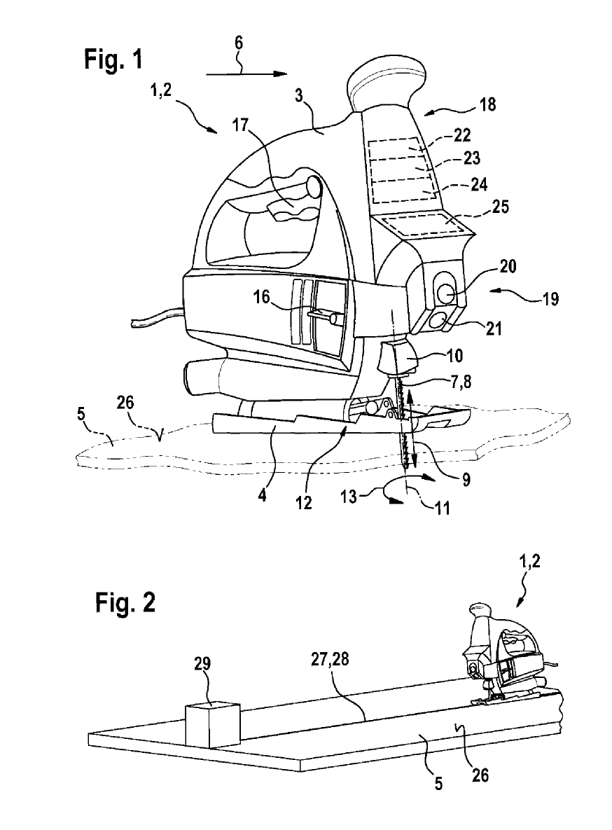

FIG. 1 shows a simplified perspective illustration of a hand-held power tool in the form of a jigsaw, and

FIG. 2 shows, in a highly schematic manner, the jigsaw put onto a workpiece and with its work tool oriented toward a working line which is predetermined via a light beam on the workpiece surface.

A jigsaw 2 is illustrated in FIG. 1 as an example of a power tool 1. Said jigsaw 2 has a housing 3 and is supported on a workpiece 5 via a sole plate 4. At its front end in working direction 6, the jigsaw 2 is provided with a work tool 7 in the form of a saw blade 8 which can be driven in a reciprocating manner in the direction of the arrow 9. The saw blade 8 of the electrically driven jigsaw 2 is held in a tool receptacle 10.

The saw blade 8 movable in a reciprocating manner in its longitudinal direction according to the arrow 9 can be rotated about a rotation axis 11 which coincides with its stroke axis. Furthermore, the saw blade 8 can be acted upon on the back thereof via an actuator 12. It is thus possible on the whole to operate the jigsaw 2 in various operating modes, firstly in normal working operation with saw blade 8 oriented fixedly in working direction 6 in order to make saw cuts along a straight line. Also possible is a “pendulum stroke operation”, in which the saw blade 8 is moved in a pendulous manner, in a manner superimposed on the stroke drive, in the respective working direction via the actuator 12 about a transverse axis (not shown here) perpendicular to the rotation axis 11. A third operating mode can be realized by using the rotatability of the saw blade 8 about its rotation axis 11 in the direction of the arrow 13. In this operating mode, in which the jigsaw 2 works as a scrolling jigsaw, the saw blade 8 can be shifted into angular working directions relative to its straight-ahead working direction according to arrow 6, which corresponds to the basic working position, and can thus be operated as a “semiautonomous jigsaw” 2 with respective orientation toward a predetermined working line to be followed by the saw blade 8. In this operating mode, the user holding the jigsaw 2 performs the task of essentially only roughly orienting the jigsaw 2 toward a respective working line and also the task of feeding the jigsaw 2. However, the exact positioning oriented toward a working line 27 as a specified path is effected by the change in the rotary position of the saw blade 8.

A switching device 16 is provided for changing over between the various above-mentioned operating modes; the jigsaw 2 is switched on and off via a switching arrangement 17, which in the exemplary embodiment shown is provided in the region of the handle of the housing 3, which on the front side, that is to say at the front in working direction 6, has an end face 18 with a nose-like projection 19, which protrudes in the bottom region in an overlapping manner relative to the tool receptacle 10. As indicated schematically, an optical detection unit 20, possibly also a lighting unit 21, is provided in said projection 19. The optical detection unit 20 comprises a sensory system, preferably in the form of a camera, but possibly also comprises different sensory systems which can be operated in adaptation to various working conditions. If a lighting arrangement is provided, said lighting arrangement 21 is preferably oriented toward the zone surrounding the working region of the saw blade 8, which passes through the sole plate 4, put onto the workpiece 5, in the region of a working aperture, a factor which is not shown in detail.

In addition to the optical detection unit 20 and possibly the lighting arrangement 21, a computing unit 22, a control unit 23 and an actuating unit 24, which are shown symbolically by dashed lines in the front region of the housing 3, are integrated into the jigsaw 2. The conditions detected by the optical detection unit 20 are transmitted as corresponding signals to the computing unit 22, are processed there, are fed to the control unit 23 and release actuating commands to the control unit 24 when required, via which the saw blade 8 is oriented in its direction of rotation toward a respective working line 27 to be followed.

The arrangement of a display 25 is schematically shown in the transition region to the nose-like projection 19, said display 25 serving, for example, to make clear the course of a respective working line 27 to be followed and the position of the saw blade 8 relative to said working line 27 and to give the user instructions as to the direction in which he should expediently support the jigsaw 2 in order to optimally bring the supporting direction and the working direction, predetermined by the rotary position of the saw blade 8, into line with the respective working line 27 to be followed.

FIG. 1 shows only the basic assignment and support of the jigsaw 2 put onto the surface 26 of the workpiece 5, which in hitherto known forms of use for the jigsaw 2 is provided with a marking on the surface in the form of a pencil line or the like as working line.

In the solution according to the invention, this “working line” 27, as shown in FIG. 2, is predetermined optically in a non-contact manner relative to the workpiece 5 by a light beam 28 which is emitted by an optical projector 29, for example a line laser. This optical projector 29, in the exemplary embodiment, and this merely for illustrating the guiding system according to the invention, is put onto the workpiece, but can also be arranged and/or held outside the workpiece 5, specifically in an orientation in which the emitted light beam projects the line to be followed by the saw blade 8 as working line 27 onto the workpiece surface 26. Oriented toward the working line 27, the jigsaw 2, only shown in outline in FIG. 2, is put onto the workpiece 5, and in this mutual orientation the working line 27 in the form of the light beam is recognized by the optical detection unit 20, which is provided, for example, as a camera, and is converted by the downstream electronic devices in the form of the computing unit 22 and the control unit 23 into control commands for the actuating unit 24, via which the saw blade 8 is oriented toward the working line 27 by rotation of the stroke rod (not shown here) of said saw blade 8.

The arrangement of the optical projector 29 on the workpiece 5 is only shown by way of example. The optical projector 29 can also be shifted upward relative to the workpiece 5, for example it can be arranged above the workpiece 5, whereby the possibility is also offered of projecting a working line 27 deviating from a straight line onto the workpiece surface 26, which working line 27, in the manner described, can be followed by the jigsaw 2 in the semiautonomous operation thereof, but if need be also in a manually guided manner. It is also within the scope of the invention to orient the light beam emanating from an optical projector directly toward the detection unit 20 and to control the rotary position of the saw blade 8 according to deviations from a predetermined orientation of the light beam toward the detection unit, in particular from the orientation of the light beam perpendicular to the detection unit 20.

Such guidance of the jigsaw 2 along a light beam as a directional beam can also be used in order to project the latter onto the workpiece surface 26, for example by optical deflection of said directional beam, for instance by reflection thereof on a mirror arrangement provided on a front side of the jigsaw 2, such that it appears there as a section of a working line which could be detected and subsequently converted into actuating signals via a detection unit 20, which could also be arranged, for example, in place of the lighting unit 21.

1. A guiding system for a power tool tool comprising a work tool and an optical detection device provided on the power tool for a working line to be followed on the workpiece by the work tool, wherein the working line is predetermined optically relative to the workpiece in a non-contact manner.

2. The guiding system as claimed in claim 1, wherein the working line is predetermined via a light beam emitted from an optical projector.

3. The guiding system as claimed in claim 1, wherein the working line is projected onto the workpiece by a light beam which runs toward the detection unit along a surface of the workpiece.

4. The guiding system as claimed in claim 1 wherein the working line is projected onto the workpiece by a light beam perpendicular to the surface.

5. The guiding system as claimed in claim 2, wherein the light beam is oriented in an impinging manner toward the optical detection unit in such a way that the projection of the light beam onto the surface of the workpiece corresponds to a working line.

6. The guiding system as claimed in claim 1, wherein the optical projector includes a laser beam emitter.

7. The guiding system as claimed in claim 6, wherein the laser beam emitter includes a line laser.

8. The guiding system as claimed in claim 1, wherein said guiding system has, as detection unit, a sensor system, the signals of which are fed to a downstream computing and control unit and are converted via the latter into guide instructions for the user and/or actuating commands for the orientation of the saw blade toward a respective rotary position.

9. The guiding system as claimed in claim 1, further comprising a jigsaw having a saw blade, wherein the saw blade configured be rotated about its stroke axis as rotation axis and is oriented in a controlled manner, by rotation about its rotation axis, toward a working line to be followed.

10. A machine set, comprising:
a guiding system as claimed in claimed in claim 1; and
a jigsaw having an accessory and a saw blade, which is driven in a reciprocating manner, and is configured to be rotated about a rotation axis running in the stroke direction and is configured to be oriented via an actuating unit toward a working line to be followed on the workpiece, said working line being detected via a sensory system provided on the jigsaw, the signals of which sensory system are converted into actuating commands for an actuating unit in a computer-aided manner via a downstream control unit, wherein the accessory is an optical projector for producing a light beam as a working line to be followed for the saw blade.
